(19) United States
(12) Patent Application Publication
(10) Pub. No.: US 2008/0088919 A1
(43) Pub. Date: Apr. 17, 2008

(54) Illumination device for a microscope

(75) Inventor: Kazuhiro Hayashi, Tokyo (JP)

Correspondence Address: ARNOLD INTERNATIONAL, P. O. BOX 129, GREAT FALLS, VA, 22066-0129, US

(73) Assignee: OLYMPUS CORPORATION

(21) Appl. No.: 11/905,427

(22) Filed: Oct. 1, 2007

(30) Foreign Application Priority Data
Oct. 16, 2006 (JP) 2006-281416

(51) Int. Cl. G02B 21/06

(52) U.S. Cl. 359/385

(57) ABSTRACT

An illuminating device for a microscope is disclosed that is equipped with an optically transparent sample mounting plate for mounting a sample, a surface light source that emits substantially uniform illuminating light toward the sample mounting plate, and optical directional members that limit the diffusion of the illuminating light between the surface light source and the sample mounting plate. The optical directional members are equipped with a switching mechanism that selectively arranges one of different types of optical directional members between the sample mounting plate and the surface light source. Additionally, an optical directional member is mounted on a retainer so as to retain and incline the optical directional member at an angle relative to the sample mounting plate.

This application claims benefit of foreign priority under 35 U.S.C. 119 of Japanese Patent Application No. 2006-281416 filed on Oct. 16, 2006, the contents of which are hereby incorporated by reference.

### TECHNICAL FIELD OF THE INVENTION

The present invention relates to a transmission illuminating device for a microscope that uses a surface light source.

### BACKGROUND OF THE INVENTION

In a microscope, arranging for an appropriate illuminating device is an important factor because a sample to be observed by a microscope appears differently according to the manner in which the sample is illuminated. If appropriate illumination cannot be provided, even though a sample within a field of view is brought into focus, a satisfactory image of the sample will be difficult to obtain.

In a conventional microscope, an illuminating device having many adjustment functions that allow, for example, a field stop and an aperture stop to be varied (as in an illuminating device that employs Kohler illumination) has been used. Appropriate adjustment of the illumination of a sample based on the optical characteristics of the sample demonstrates the performance capabilities of the microscope. For example, as a technique to easily observe a transparent and colorless sample with less coloration and refraction of light based on the sample being unstained and having only a small refractive index difference from a surrounding medium, a method to observe the sample by stopping down the aperture stop and reducing the numerical aperture of the illumination is known.

However, conventional illuminating devices for microscopes, including those that provide Kohler illumination, have problems and/or limitations. For example, often the configuration of the illuminating device body becomes complicated, resulting in a large microscope. Furthermore, the configuration of the illuminating device body can cause a microscope to become difficult to operate by a user.

In Japanese Laid-Open Patent Application No. 2005-316163, a microscope having an illuminating device that employs a surface light source using white light LEDs is disclosed. In the illuminating device, although a sample is illuminated from below and the illuminating device is configured to be thin, the illuminating angles of the illuminating light are limited to those that define, in one direction, a small numerical aperture of the illuminating beam. This is achieved by mounting and arranging an optical directional member between the surface light source and the sample.

However, the optical directional member disclosed in Japanese Laid-Open Patent Application No. 2005-316163 uses a louver film that, due to its structure, can provide angular directivity of the illuminating light in only one direction. This is vastly different from the situation of the illumination having angular directivity in multiple directions simultaneously, as when the illumination is limited in all directions to define a conical light beam having a small numerical aperture by using an aperture stop. Such a great difference in the illuminating lights results in a sample appearing differently under the two different illuminations. As shown in FIG. 16A, the optical directional member may have a characteristic such that, as the illuminating angle becomes larger in one direction (here the Y direction), the transmittance of the optical directional member becomes gradually lower. In the other direction (i.e., in the X direction) the transmittance is constant as the illuminating angle becomes larger. This is different from illuminators generally used with microscopes, and results in the appearance of the sample being different. When using a louver film as the optical directional member, optical directivity is provided in only one direction. As a result, the illuminating light cannot be sharply decreased at a specific illuminating angle, and thus the outline of a comparatively transparent sample will only gradually change from dark to light. In other words, when attempting to show the outline of a nearly transparent sample, sufficient performance cannot be obtained to clearly image the outline of the sample when using a louver film to control the illuminating light.

Other types of optical directional members are also known. For example, a member referred to as a fiber optic plate, which may be a fiber optic faceplate as that term is defined in the Optical Technical Term Dictionary published by The Optronics Co., Ltd., is formed by arranging a bundle of many optical fibers as a plate that, in use, provides directivity to transmitted light. For example, Japanese Laid-Open Patent Application No. H04-77703 discloses such an illuminating device.

Furthermore, an optical directional member referred to as a capillary plate is also known. For the capillary plate, a bundle of capillaries (tubules of glass) are formed as a plate. The capillary plate functions to only transmit light rays that are incident perpendicular to the plane of the plate (i.e., only collimated light in line with the capillaries exits the capillaries), thus providing directionality of the light passing through the capillary plate. Japanese Laid-Open Patent Application No. H 11-258508 discloses an illuminating device that uses such a capillary plate as an optical directional member to control the illuminating light.

However, the Japanese publications referenced above describe illumination devices that are designed for the effective use of illuminating light or for high accuracy of illumination, and thus these devices have not been designed based on the optical characteristics of a particular object to be illuminated.

As an illuminating device for a microscope, it is important to selectively obtain an appropriate illuminating condition according to a sample condition or an observation optical system condition, and since the illuminating devices described above are not considered as illuminating devices for microscopes, sufficient conditions for using the devices as illuminating devices for microscopes have not been established.

### BRIEF SUMMARY OF THE INVENTION

The present invention relates to an illuminating device for a microscope that is equipped with an optically transparent sample mounting plate for mounting a sample, a surface light source that emits substantially uniform illuminating light toward the sample mounting plate, and different types of optical directional members that limit the diffusion of the illuminating light between the surface light source and the sample mounting plate, wherein the optical directional members are equipped with a switching mechanism that selectively arranges a selected one of the different types of optical directional members between the sample mounting plate and the surface light source.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 is a side view of a microscope and a transmissive illumination pedestal using an illuminating device of the present invention, with the transmissive illumination pedestal shown in cross-section;

FIG. 2 is an enlarged cross-sectional view of the transmissive illumination pedestal shown in FIG. 1 as viewed from the direction of the arrows labeled II-II in FIG. 1;

FIG. 3 is a further enlarged cross-sectional view of a portion of the transmissive illumination pedestal shown in FIG. 2 as viewed from the direction of the arrows labeled II-II in FIG. 1;

FIG. 4 is a plan view of the optical directional member table equipped with different types of optical directional members;

FIG. 5 is an enlarged cross-sectional view, in the direction indicated by the arrows V-V of FIG. 4, taken along the section line indicated in FIG. 4;

FIG. 6 is a perspective view of a fiber optic plate;

FIG. 7 is a lengthwise cross-sectional view of an optical fiber showing the reflection and refraction of light rays in the optical fiber;

FIG. 8 is a side view of a fiber optic plate arranged in parallel with a surface light source;

FIG. 9 is a side view of a fiber optic plate arranged so as to be inclined relative to a surface light source;

FIGS. 10A and 10B are diagrams that show top and side views, respectively, of a glass bead that is illuminated from below using light having a numerical aperture of 0.1;

FIGS. 11A and 11B are diagrams that show top and side views, respectively, of a glass bead that is illuminated from below using light having a numerical aperture of 0.99;

FIG. 12 is a cross-sectional view of a prism sheet;

FIGS. 13A and 13B are cross-sectional views, taken along planes that are perpendicular to each other, of an illuminating device that uses the prism sheet shown in FIG. 12;

FIG. 14 is a perspective view of a capillary plate, with a portion cut away;

FIG. 15 is a block diagram of a Kohler illumination system of a microscope;

FIGS. 16A and 16B pertain to using a louver film as an optical directional member, with FIG. 16A being a graph of transmittance versus the illuminating angle (as measured from the surface normal of the optical directional member in a plane X and a plane Y that are perpendicular to each other) in the case of an illuminating device for a microscope using a louver film, and with FIG. 16B being a diagram of an observed image (using transmitted light) of a glass bead in the case of an illuminating device for a microscope using a louver film as an optical directional member;

FIGS. 17A and 17B pertain to using Kohler illumination, with FIG. 17A being a graph of transmittance versus numerical aperture of the illumination in the case of the illuminating device for a microscope using Kohler illumination, and with FIG. 17B being a diagram of an observed image (using transmitted light) of a glass bead in the case of an illuminating device for a microscope using Kohler illumination;

FIGS. 18A and 18B pertain to using a fiber optic plate as an optical directional member, with FIG. 18A being a graph of transmittance versus the illuminating angle (as measured from the surface normal of the optical directional member) in the case of the illuminating device for a microscope using a fiber optic plate, and with FIG. 18B being a diagram of an observed image (using transmitted light) of a glass bead in the case of the illuminating device for a microscope using a fiber optic plate as an optical directional member; and

FIGS. 19A and 19B pertain to using a capillary plate as an optical directional member, with FIG. 19A being a graph of transmittance versus the illuminating angle (as measured from the surface normal of the optical directional member) in the case of the optical directional member being a capillary plate, and with FIG. 19B being a diagram of an observed image (using transmitted light) of a glass bead in the case of the illuminating device for a microscope using a capillary plate as an optical directional member.

### DETAILED DESCRIPTION

The objective of the present invention is to resolve problems caused by changing the conventional illuminating device of a microscope to an illuminating device wherein a surface light source is arranged underneath a sample. In particular, an equivalent of an aperture stop in a conventional illuminating device for a microscope is provided. In the present invention, even when a light source and a sample are in a very close positional relationship, the illuminating angles of the illuminating light may be limited to thereby define a small numerical aperture of illumination. Furthermore, optimal conditions for the illumination may achieved by reason of the illuminating conditions being easily adjustable. Thus, not only can the numerical aperture of the illumination be reduced, but also optimal illuminating conditions can be simultaneously achieved.

Problems of conventional illuminating devices are resolved in the present invention that uses an optically transparent sample mounting plate for mounting a sample, a surface light source that emits substantially uniform illuminating light toward the sample mounting plate, and different types of optical directional members that limit the diffusion of the illuminating light between the surface light source and the sample mounting plate. The different types of optical directional members are equipped with a switching mechanism that selectively arranges one of the different types of optical directional members between the sample mounting plate and the surface light source. The different types of optical directional members may include, for example, a fiber optic plate, a capillary plate, and a louver film. By using different types of optical directional members, the illumination conditions can be varied. Additionally, it is preferable to mount the different types of optical directional members on retainers that may be inclined so as to achieve optimal light directing characteristics.

Additionally, the present invention may use a prism sheet for use in a stereoscopic microscope. In this case, the illuminating device for a stereoscopic microscope includes an optically transparent sample mounting plate for mounting a sample, a surface light source that emits substantially uniform illuminating light to the sample mounting plate, and optical directional members that limit diffusion of the illuminating light between the surface light source and the sample mounting plate, wherein the prism sheet is arranged between the optical directional members and the sample mounting plate. With such a configuration, a sample can be appropriately illuminated for making stereoscopic observations with a stereoscopic microscope.

Embodiments 1 and 2 of an illuminating device for a microscope according to the present invention will now be individually described with reference to the drawings.

### Embodiment 1

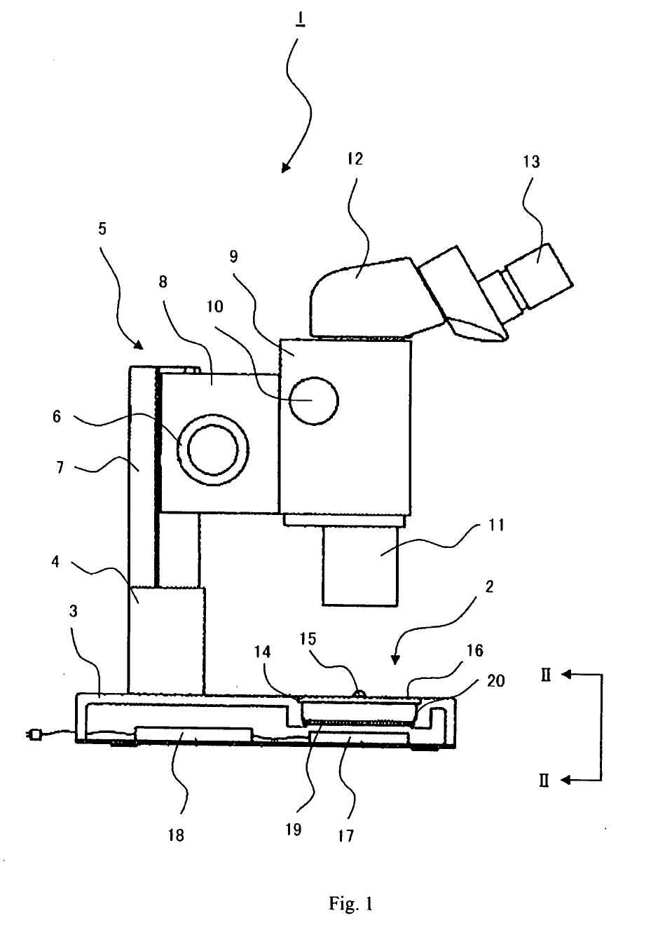

FIG. 1 is a side view of a microscope and transmissive illumination pedestal using an illuminating device of the present invention with the transmissive illumination pedestal shown in cross-section.

As shown in FIG. 1, a microscope 1 is equipped with a transmissive illumination pedestal 2 that is composed of a horizontally arranged base 3 and a support 4 arranged perpendicular to the base 3. Additionally, in FIG. 1, a focusing device 5 is arranged on the support 4, and the focusing device 5 incorporates a focusing mechanism (not shown). The focusing mechanism moves a movable part 8 along a fixed part 7 when a focusing handle 6 is adjusted.

Furthermore, a microscope body 9 that incorporates a zoom lens is arranged on the movable part 8 of the focusing device 5 in order to accomplish zooming according to operation of a zooming handle 10. In addition, an objective lens 11 having an optical axis is arranged below the microscope body 9, a lens barrel 12 is arranged on the top of the microscope body 9, and an ocular lens 13 for observation is arranged on the lens barrel 12. Also, a hole 14 is arranged on the upper surface of the base 3 facing the objective lens 11 of the microscope 1 in FIG. 1. A plate 16, which is an optically transparent sample mounting plate for mounting a sample 15, is inserted into the hole 14. A surface light source 17 that emits uniform light is arranged below the plate 16 and illuminates the sample 15 from below through the plate 16. A light source 18 is connected to the surface light source 17, a commercial light source supply (not shown) is connected to the light source 18, and a power source (not shown) supplies power for providing light at the surface light source 17 by operation of a switch (not shown).

Additionally, as shown in FIG. 1, an optical directional member 19 is arranged at a position between the surface light source 17 and the plate 16 where the sample 15 is mounted. Furthermore, as shown in FIG. 1, in the microscope 1, the optical directional member 19 is supported by a retainer 20 formed in the base 3.

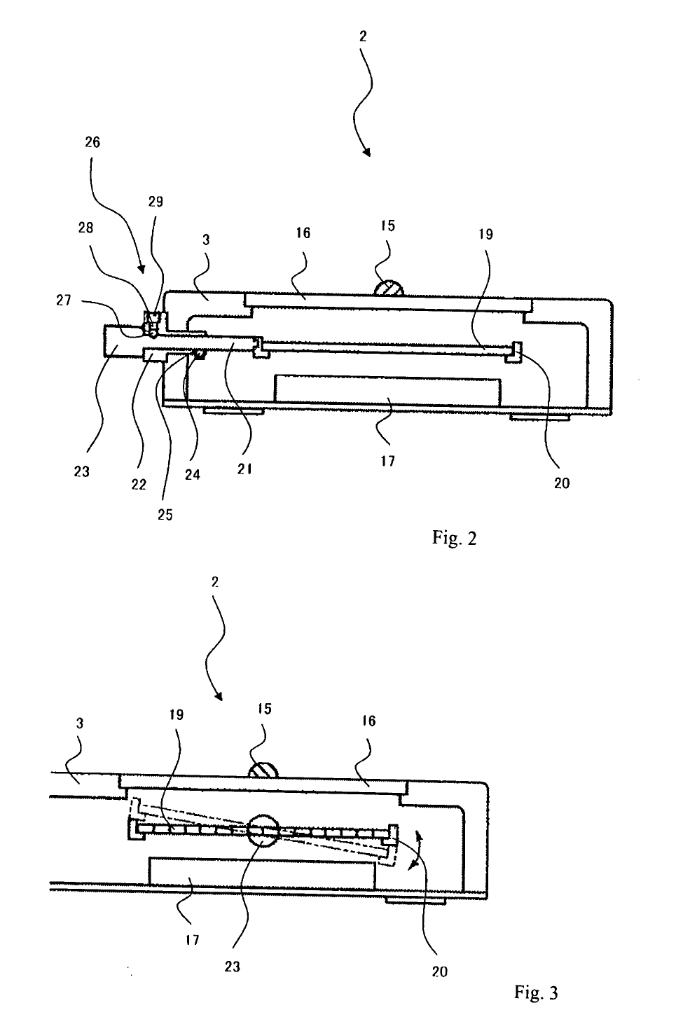

FIG. 2 is an enlarged cross-sectional view of the transmissive illumination pedestal 2 of FIG. 1 from the line 11-11 direction of FIG. 1. FIG. 2 shows the transmissive illumination pedestal 2 equipped with the retainer 20 in which the optical directional member 19 is mounted at a position between the surface light source 17 and the plate 16.

As shown in FIG. 3, which is a further-enlarged, cross-sectional view of a portion of the transmissive illumination pedestal as viewed in the direction of the arrows II-II of FIG. 1, the transmissive illumination pedestal 2 enables rotation of the optical directional member 19 about an axis that is perpendicular to the optical axis of the objective lens 11 while the optical directional member 19 is mounted on the retainer 20.

Additionally, referring again to FIG. 2, the transmissive illumination pedestal 2 is equipped for adjustment of the inclination of the retainer 20 on which the optical directional member 19 is mounted using a shaft 21 on which the retainer 20 is arranged, a bearing 22 that retains the shaft 21 while allowing the shaft to rotate, and an operation knob 23 arranged at one end of the shaft 21. Furthermore, in the transmissive illumination pedestal 2, a screw 24 is screwed into the shaft 21. The screw 24 interlocks in a groove 25 arranged in the bearing 22, and serves to control rotation of the shaft so as to prevent the bearing from falling off. Also, in the transmissive illumination pedestal 2, a hole 26 is arranged in the bearing 22, and a ball 27, a spring 28, and a screw 29 are inserted into the hole 26. The ball 27 is pressed against the shaft 21 by the force of the spring 28, which serves to confine the rotation of the shaft 21 at a selected angle.

In FIG. 3, in the transmissive illumination pedestal 2, the retainer 20 is moved by turning the operation knob 23, which causes the inclination of the optical directional member 19 mounted on the retainer 20 to vary. The optical directional member 19 that is inclined by the retainer 20 is inclined so as to lie generally in a plane that is other than perpendicular to the optical axis of the objective lens 11.

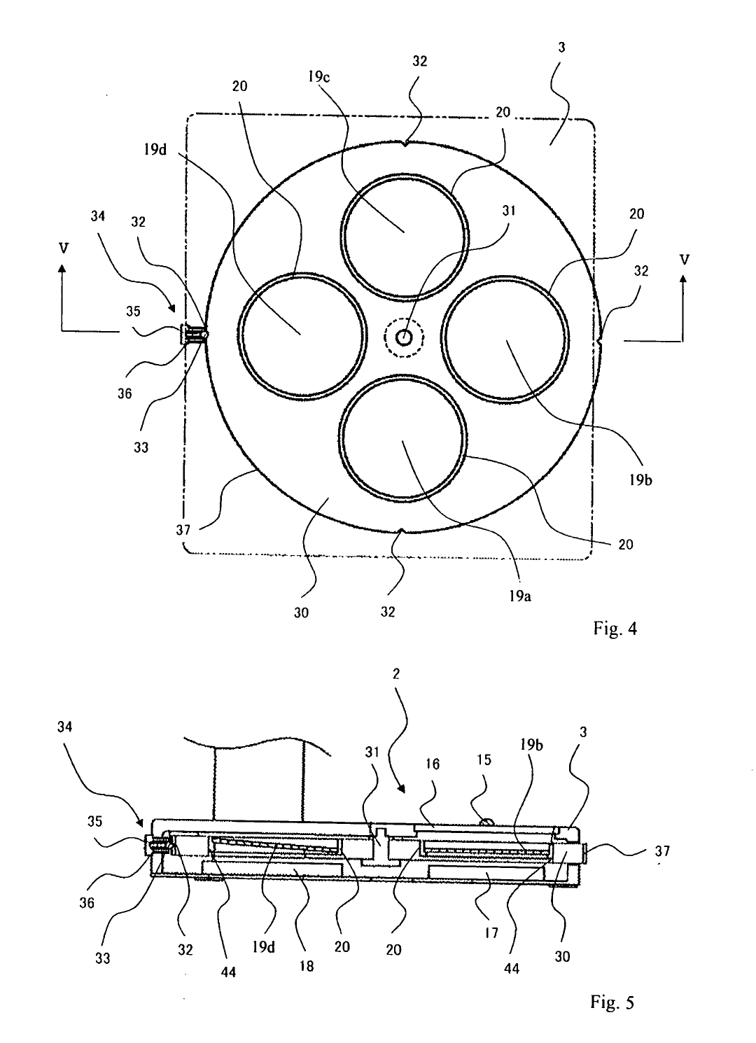

FIG. 4 is a plan view of an optical directional member table 30 equipped with different types of optical directional members 19a-19d. In FIG. 4, a rotary shaft 31, the retainers 20, 20, 20, 20 and click stop grooves 32, 32, 32, 32 are arranged in the optical directional member table 30.

Additionally, FIG. 4 shows that retainers 20 are arranged in the optical directional member table 30, and a different type of optical directional member is mounted in each of the retainers 20. The different types of optical directional members 19a-19d are mounted so as to be detachable. Furthermore, as shown in FIG. 4, the optical directional member table 30 is arranged so as to rotate around the axis of the rotary shaft 31 when a finger applies a turning force to the operating part 37. Also, as will be described later, the different types of optical directional members 19a-19d are each held by a retainer 20 that may be oriented at different angles to the illuminating light, thereby making it possible to irradiate light to the sample 15 via the different types of optical directional members 19 positioned at different angles to the plate 16 by the rotating movement of the optical directional member table 30 around the axis of rotation of the shaft.

Moreover, as shown in FIG. 4, as the optical directional member table 30 rotates around the axis of the rotary shaft 31, a position where a stop ball 33 and the click stop groove 32 are engaged is reached wherein the position of the objective lens 11 is aligned with a particular optical directional member 19.

A stopper device 34 will now be described with reference to FIG. 4. The stopper device 34 is a device to engage with the click stop grooves 32, 32, 32, 32 and it is equipped with a plunger 35, a stop spring 36, and the stop ball 33. Additionally, the stopper device 34 incorporates the stop spring 36 and the stop ball 33, and the stopper device 34 is pushed and closed by the plunger 35. The stop ball 33 is pressed against the outer circumferential surface of the optical directional member table 30 by the stop spring 36. Furthermore, the stopper device 34 controls the turning of the optical directional member table 30 by depressing the stop ball 33, which is pressed against the outer circumferential surface of the optical directional member table 30, into the click stop grooves 32 arranged on the outer circumferential surface of the optical directional member table 30.

FIG. 5 is an enlarged cross-sectional view along the line V-V of FIG. 4. FIG. 5 shows the different types of optical directional members 19a-19d mounted in the retainers 20 at different angles to the illuminating light. In particular, it can be seen that the optical directional member 19d mounted in a retainer 20 is inclined so as to lie generally in a plane that is not perpendicular to the optical axis of the objective lens 11, since the retainer 20 is inclined relative to the sample mounting plate 16. With this design, turning the optical directional member table 30 causes the irradiation of the light emitted from the surface light source 17 to the plate 16 via the optical directional members 19a-19d to be at different angles.

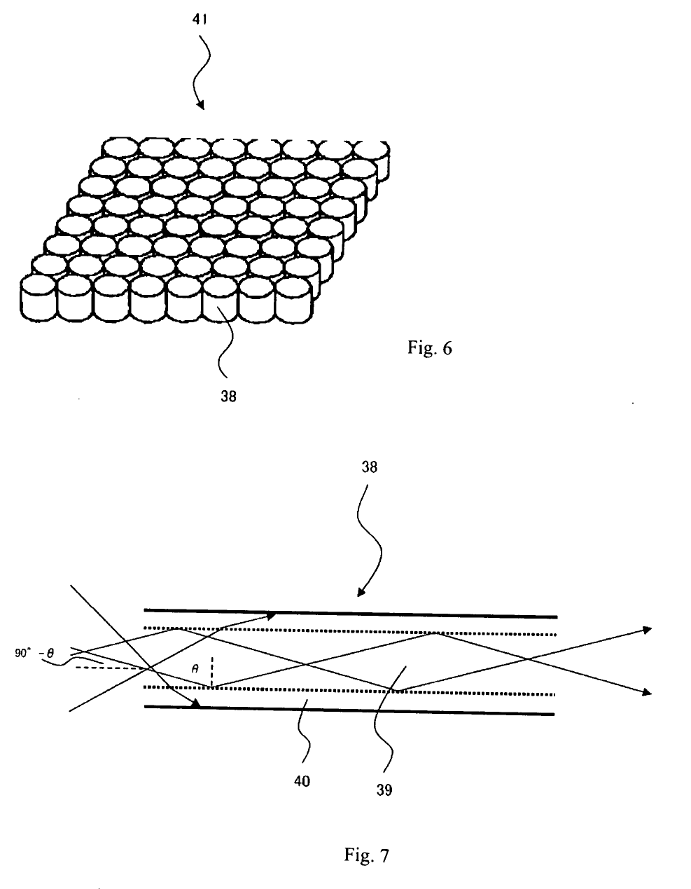

An example of an optical directional member that may be used in the present invention will now be described with reference to FIG. 6. As shown in perspective view in FIG. 6, the optical directional member may be a fiber optic plate 41 that limits the diffusion of the illuminating light emitted from the surface light source. In the fiber optic plate 41, as is typical of fiber optic plates, a multitude of optical fibers 38 are arranged in parallel with each other, and the fiber optic plate 41 is formed as a relatively thin flat plate. As shown in FIG. 6, the arrangement of the optical fibers 38 in the fiber optic plate 41 may be closely packed as in a honeycomb arrangement.

FIG. 7 is a lengthwise cross-sectional view of an optical fiber showing the reflection and refraction of light in the optical fiber 38. Each optical fiber 38 is formed with a core part 39 with a high refractive index and a clad part 40 with a lower refractive index. According to the difference of the refractive index between the core part 39 and the clad parts 40, a light beam that proceeds into the optical fiber 38 at an angle that is more acute than a certain angle, namely—the complement of the critical angle θ, travels through the core part 39 with repeated total internal reflections.

In other words, the fiber optic plate 41 having a configuration with bundled optical fibers functions to output only those light rays that are incident onto the optical fibers 38 at an angle that is more acute than the angle which is the complement of the critical angle θ (i.e., 90°−θ). This results in a directionality of output light with varied intensity in different directions that is controlled by the difference of refractive index between the core part and the clad part, and optical fibers having numerical apertures in the range of approximately 0.3-0.6 are commercially available.

Another type of optical directional member that may be used in the present invention is a capillary plate. FIG. 14 is a perspective view of a capillary plate 43, with a portion cut away. In this capillary plate 43, capillaries with diameters of several μm to several dozen μm are formed in glass tubules that are two-dimensionally arranged. The glass tubules are then formed into a relatively thin, integral flat plate. As a result, the capillary plate 43 functions to transmit light rays only if the light rays are aligned with the capillaries.

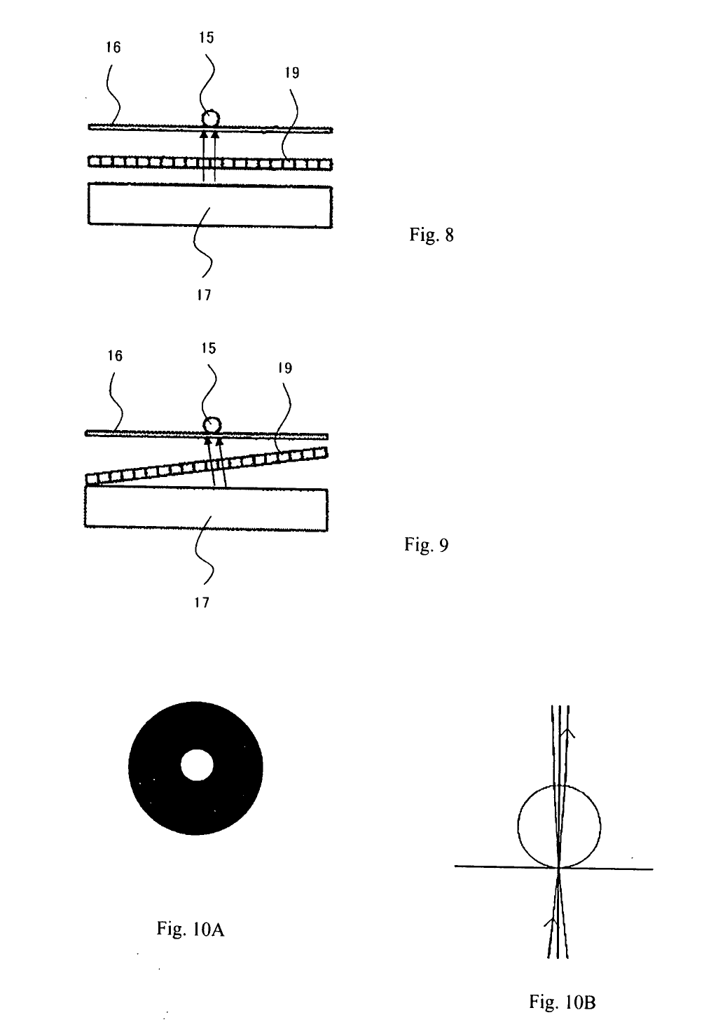

The operation of the present invention will now be described with reference to FIGS. 8 and 9. FIG. 8 is a side view of the optical directional member 19 arranged in parallel to the plate 16 and the surface light source 17. FIG. 9 is a side view of the optical directional member 19 arranged to be inclined relative to the plate 16 and the surface light source 17.

As shown in FIG. 8, when the optical directional member 19 is arranged in parallel with the plate 16, an illuminating light from the surface light source 17 is irradiated only from directly below. On the other hand, as shown in FIG. 9, when the optical directional member 19 is arranged to be inclined relative to the plate 16, only light rays from the surface light source 17 that are sufficiently aligned with the optical axis of the optical directional member are incident onto the lower side of the plate 16. In other words, in this arrangement, the inclination of the optical directional member 19 determines the characteristics of the light incident on the plate 16.

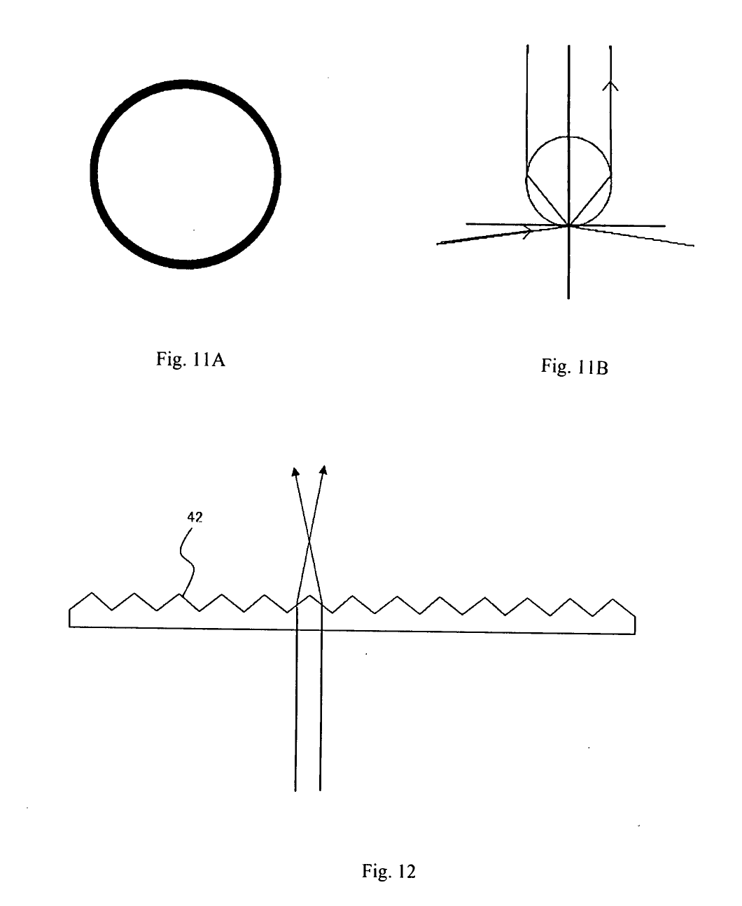

Illuminating effects possible in the present invention will now be described with reference to FIGS. 8 and 10A-19B. It will be easier to understand the conditions of the illuminating light reaching a sample by considering a transparent globe, such as a glass bead that is placed on the plate 16 of the illuminating device and illuminated from below, as shown in FIG. 8. As shown in FIGS. 10A, 10B, 11A, and 11B, the numerical aperture of the illuminating light entering a glass bead as a sample object corresponds to the range within the glass bead where the sample object appears bright; these figures should assist in understanding the illuminating conditions possible with the present invention.

FIG. 10A shows a top view where the light that illuminates the glass bead has a small numerical aperture of 0.1. Because the illuminating light enters the glass bead with only a small numerical aperture, light is transmitted through only a portion of the upper surface of the glass bead, as shown in the side view of FIG. 10B. In this situation, when the glass bead is viewed from overhead, only the center portion appears bright and the outer portion appears black, as shown in FIG. 10A. When the numerical aperture of the illumination light is small, even if the sample is comparatively transparent, as long as there is slight refraction of light due to the index of refraction of the sample being different than its surroundings, it is possible to clearly and emphatically view the outline of even such an uncolored, transparent sample by the sample's refraction of light.

Next, a case where a glass bead is illuminated with light having an extremely large numerical aperture of 0.99 will be described with reference to FIGS. 11A and 11B, that show top and side views, respectively. In this case, illuminating light enters into the glass bead from a large variety of angles and light is transmitted through almost the entire upper surface of the glass bead. When the glass bead is viewed from overhead, almost the entire portion viewed appears bright, with only a small black circumferential ring appearing dark, as shown in FIG. 11A. In this illumination condition, an entirely transparent sample that refracts light less than a glass bead would appear completely bright and this would make it difficult to view any outline or sample features related to refraction of the light by the sample.

Thus, as described above, the appearance of a sample such as a glass bead that is transparent will vary when viewing the light transmitted by the sample, depending on the illuminating condition.

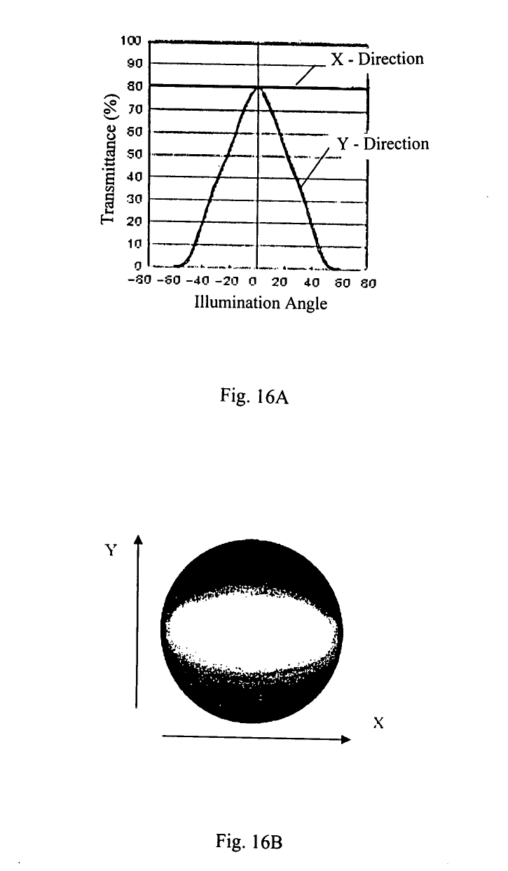

In the illuminating device disclosed in Japanese Laid-Open Patent Application No. 2005-316163, the optical directional member to be used is a louver film, and the relationship between the transmittance of the louver film and the illuminating angle (as measured in degrees from the surface normal of the optical directional member in two directions, X and Y, that are perpendicular to each) is shown in FIG. 16A. Because the optical directivity of a louver film intensifies the light in only a single direction, a glass bead placed on the illuminating device will appear as shown in FIG. 16B. As can be seen in FIG. 16B, the glass bead appears white nearly to the full diameter of the glass bead in the direction X where no optical directivity is provided, and only the center portion of the glass bead appears bright in the direction Y where optical directivity is provided by the louver film. However, in this case, the light and dark portions are not clearly separated, but rather an intermediate area between a bright center portion and a black circumference portion gradually becomes darker. In other words, a gradually darkening outline is obtained for a comparatively transparent structure.

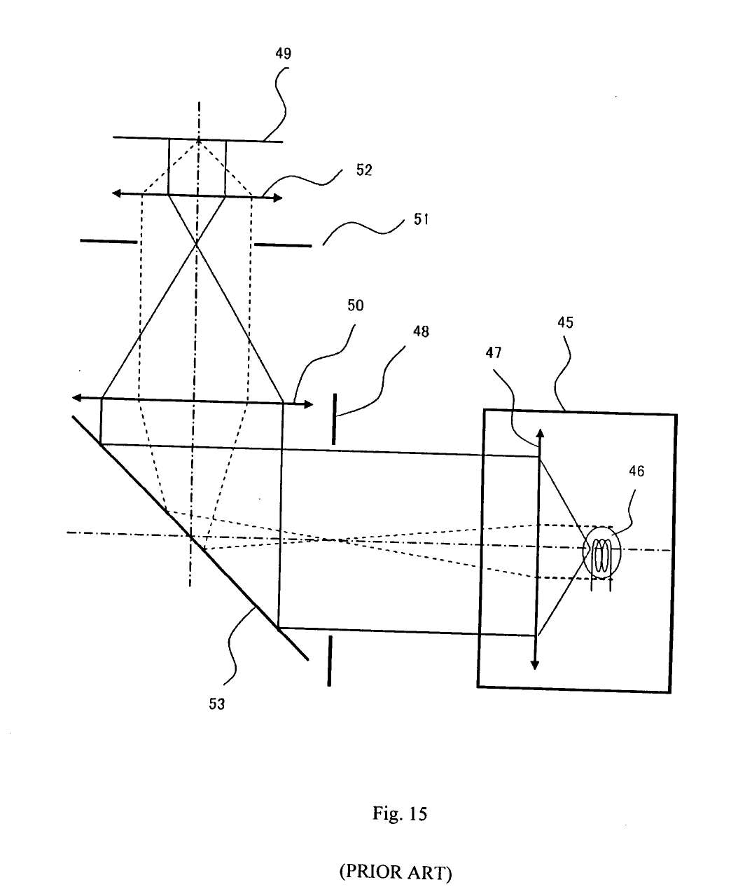

Next, how this problem has been solved by a conventional illuminating device for a microscope will be described. For this purpose, the configuration of a Kohler illumination system, which is a typical example of a conventional illuminating device, will be described with reference to FIG. 15, which illustrates a Kohler illumination system.

As shown in FIG. 15, a lamp housing 45 includes a light source 46 that emits light and a collector lens 47 that converts divergent light emitted from the light source 46 into collimated light. Furthermore, a field stop 48 that limits the numerical aperture of the illumination light is arranged at a position optically conjugate with a surface to be illuminated 49. The collimated light from the lamp housing 45 passes through the field stop 48, and is converged onto the surface of an aperture stop 51 by a field lens 50. Then, the light from the light source passes through a condenser lens 52 and is incident onto the surface to be illuminated 49. Item 53 in FIG. 15 is a mirror.

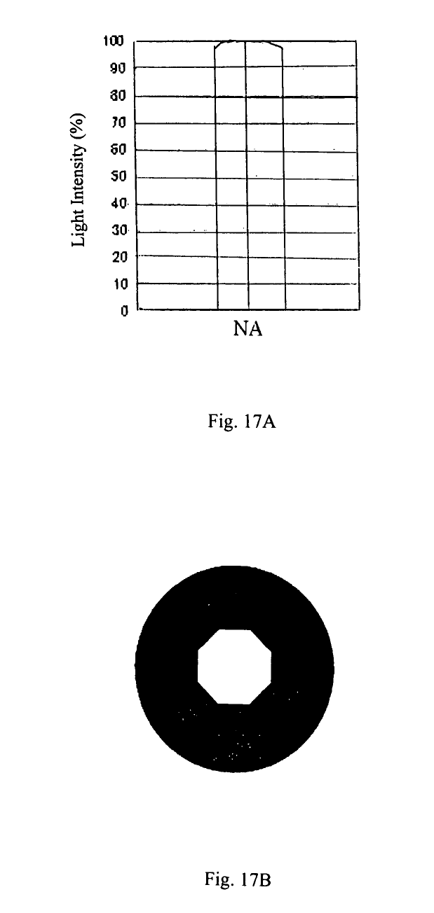

In a Kohler illumination system, the aperture stop 51 functions to limit the numerical aperture of the illuminating light. As shown in FIG. 15, the aperture stop 51 functions to limit a luminous flux of the illuminating light that is incident onto one point of the surface to be illuminated 49. In other words, the numerical aperture of the light irradiated onto the surface to be illuminated 49 can be limited by stopping down the aperture stop 51. The adjustment of the aperture stop 51 to an optimal condition according to a sample to be observed results in an operator being able to visualize differences of refractive index between a sample and its surroundings, or of differences of refractive index in the sample itself. Furthermore, the numerical aperture NA of the illumination, as shown in FIG. 17A, is defined by the aperture stop. A glass bead placed on this illuminating device appears as shown in FIG. 17B. The bright range in the center portion corresponds to the diaphragm diameter of the aperture stop. Unlike the situation seen in the case of the illuminating device using a louver film, there is no gradation in the image in FIG. 17B, so the outline of a comparatively transparent structure is emphatically observed. Furthermore, the outer perimeter shape (an octagon in FIG. 17B) of the bright region when viewing a glass bead in transmission, as shown in FIG. 17B, depends on the number and the shape of the diaphragm blades that form the aperture stop.

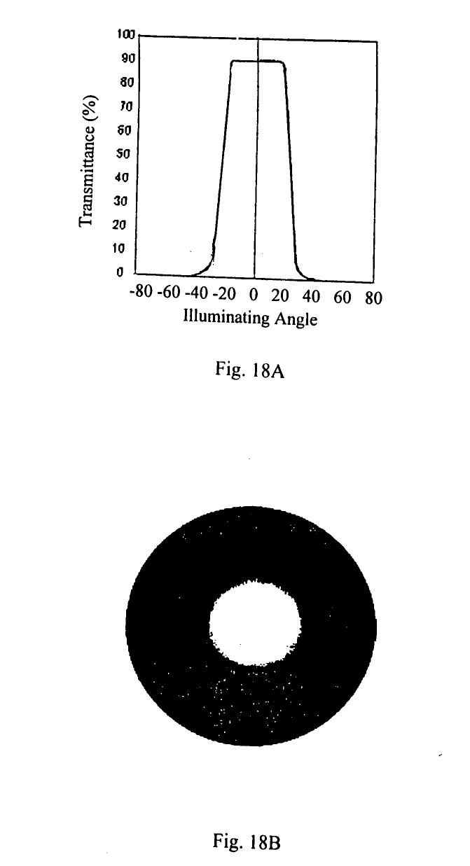

Next, a characteristic of the transmittance of the fiber optic plate and the illuminating angle, related to the numerical aperture (NA), is shown in FIG. 18A. FIG. 18A is a graph of transmittance versus illuminating angle in the case of illumination using a fiber optic plate. Even though errors in the shape and other variations of the optical fibers, with a multitude of the optical fibers bundled together, generate slight disturbances in transmitted light, only a light beam with a prescribed illuminating angle is transmitted through the fiber optic plate.

When adopting such a fiber optic plate to the illuminating device of the present invention, it is desirable to use an absorption type fiber optic plate whose clad parts are colored in order to sufficiently diminish light other than the light at the prescribed illuminating angle. In the case of using the fiber optic plate for the optical directional member, the glass bead appears as shown in FIG. 18B. The range of the bright center portion corresponds to the illuminating angle of the fiber optic plate, and, similar to the case of the Kohler illumination, an illuminating device wherein the gradation is less and the outline of a comparatively transparent structure is emphatically observed can be obtained.

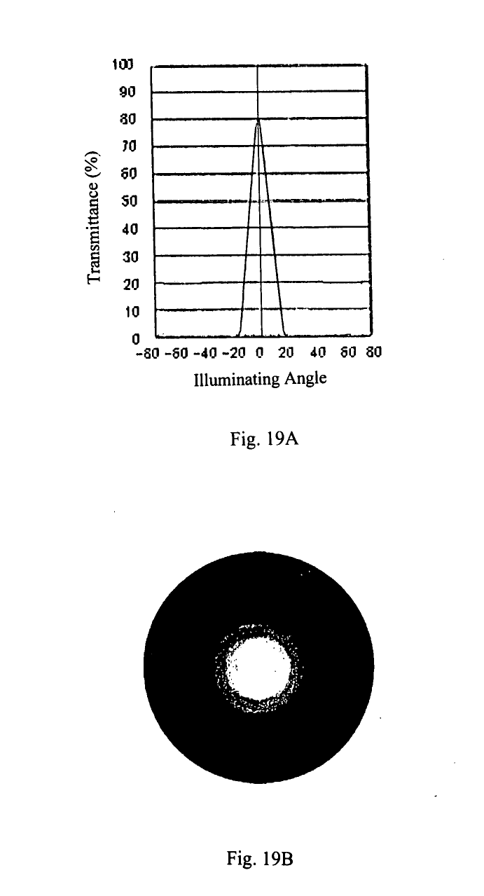

The transmittance of a capillary plate versus the numerical aperture (NA) of the incident illumination is shown in FIG. 19A. More specifically, FIG. 19A is a graph of the transmittance of the capillary plate (ordinate) versus the numerical aperture of the incident illumination (abscissa) in the case of using a capillary plate. Similar to the case where a louver film is used, as the numerical aperture of the incident illumination increases, the transmittance gradually decreases. In the case of using a capillary plate as an optical directional member, the glass bead appears as shown in FIG. 19B, which is a diagram of an observed image in the case of illumination using a capillary plate. Unlike the louver film, the capillary plate provides directivity in all circumferential directions, so that the bright range in the center portion becomes a circle. However, the bright and dark portions are not clearly separated, similar to the situation using a louver film, but the intermediate area between the bright center portion and the black circumferential portion becomes gradually darker. In other words, an illuminating device where the outline of a comparatively transparent structure gradually darkens is obtained.

As described above, it is obvious that the characteristics of the optical directional member greatly affect how a sample appears according to the use of various optical directional members, the illuminating conditions obtained by the Kohler illumination, and how a glass bead appears using each type of illumination.

In the illuminating device of the present invention, because the distance between a sample and a light source is very close, there is no space to arrange an aperture stop. Instead, in the illuminating device of the present invention, a mechanism that plays a role of an aperture stop is mounted according to different considerations.

For example, the function of reducing the numerical aperture (NA) in the aperture stop is accomplished by the optical directional member that is arranged between the surface light source 17 and the sample 15, and the function of adjusting the numerical aperture is accomplished by selecting a particular one among the different optical directional members. In particular, choosing the optical directional member to be a fiber optic plate or a capillary plate enables varying the illuminating conditions.

In order to emphatically observe the outline and the structure of a comparatively transparent structure with less refraction of light, a fiber optic plate is suitable. Furthermore, in order to observe a comparatively transparent structure with greater refraction of light so that an image is observed with appropriate light and dark differences, a capillary plate is suitable.

### Embodiment 2

Embodiment 2 of the present invention is a configuration wherein a prism sheet is combined with the optical directional member 19. Embodiment 1 of the present invention described above is designed for transmissive illumination in optical microscopes in general, and Embodiment 2 is specifically designed for stereoscopic microscopes.

A stereoscopic microscope is a microscope that enables stereoscopic observation of a sample by observing the sample from different angles with one's left and right eyes. It is preferable that the illumination for the stereoscopic microscope be modified in one direction so as to not generate unnatural shading in the one direction. In Embodiment 2 of the present invention, the illuminating light is modified in one direction using a prism sheet.

FIG. 12 is a cross-sectional view of a prism sheet 42. The prism sheet 42 has a configuration wherein triangular cross-section prisms are aligned and arranged. As a result, the luminous flux entered into the prism sheet 42 is divided into two directions, due to the refraction of the prism surface.

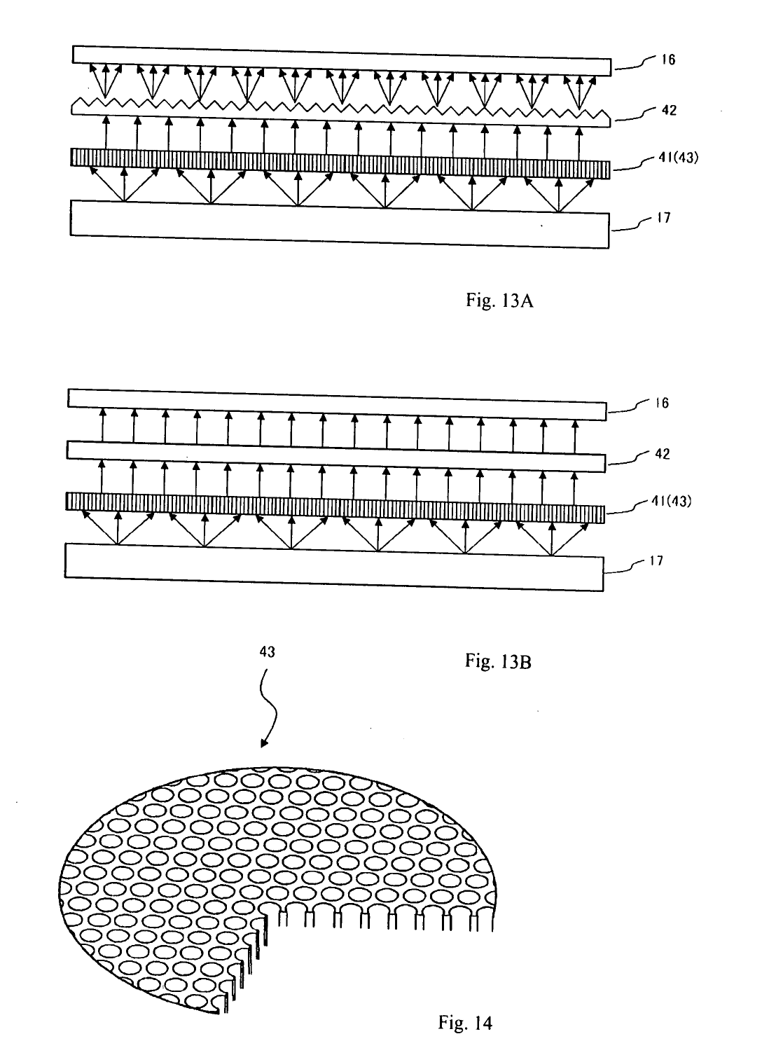

Next, the arrangement and operation of the prism sheet 42 in Embodiment 2 of the present invention will be described with reference to FIGS. 13A-13B. FIGS. 13A and 13B are perpendicular cross-sectional views of an illuminating device using a prism sheet. FIGS. 13A and 13B show the arrangement of the plate 16, the prism sheet 42, the optical directional member (for example, a fiber optic plate 41 or a capillary plate 43), and the surface light source 17. FIG. 13A shows a cross-sectional view in one direction, and FIG. 13B shows a cross-section in the direction perpendicular to the one direction. As shown in FIGS. 13A and 13B, in the arrangement of Embodiment 2 of the present invention, it is desirable to arrange the plate 16, the prism sheet 42, the optical directional member, and the surface light source 17 in that order. With this arrangement, directivity of the light beam emitted from the surface light source 17 is increased by transmission through the optical directional member 41 or 43, and it is decreased only in the horizontal direction by transmission through the prism sheet 42. As a result, even in the case of stereoscopic observation by a stereoscopic microscope, an illumination method wherein viewed samples appear natural can be obtained.

Even in this case, in order to more emphatically observe the outline and the structure of a comparatively transparent structure with little refraction of light, a fiber optic plate is appropriate. Additionally, in order to observe a comparatively transparent structure with greater refraction of light at an appropriate contrast difference, a capillary plate is appropriate.

Furthermore, even in Embodiment 2 of the present invention, similar to Embodiment 1, a mechanism to incline, rotate or shift the optical directional member may be used to function as an adjuster for adjusting the illumination to be more suitable for a sample.

The invention being thus described, it will be obvious that the same may be varied in many ways. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An illuminating device for a microscope comprising:
an optically transparent sample mounting plate for mounting a sample;
a surface light source that emits substantially uniform illuminating light toward the sample mounting plate; and
optical directional members of different types that limit diffusion of the illuminating light between the surface light source and the sample mounting plate;
wherein
the optical directional members are equipped with a switching mechanism that selectively arranges one of the different types of optical directional members between the sample mounting plate and the surface light source.

2. The illuminating device for a microscope according to claim 1, wherein the different types of optical directional members include a fiber optic plate.

3. The illuminating device for a microscope according to claim 1, wherein the different types of optical directional members include a capillary plate.

4. The illuminating device for a microscope according to claim 1, wherein an optical directional member is mounted on a retainer so as to retain and incline the optical directional member at an angle relative to the sample mounting plate.

5. The illuminating device for a microscope according to claim 2, wherein an optical directional member is mounted on a retainer so as to retain and incline the optical directional member at an angle relative to the sample mounting plate.

6. The illuminating device for a microscope according to claim 3, wherein an optical directional member is mounted on a retainer so as to retain and incline the optical directional member at an angle relative to the sample mounting plate.

7. The illuminating device for a microscope according to claim 4, wherein an optical directional member mounted on a retainer is rotatable about an axis that is parallel with the optical axis of the objective lens.

8. The illuminating device for a microscope according to claim 4, wherein an optical directional member inclined by a retainer is inclined so as to lie generally in a plane that is not perpendicular to the optical axis of the objective lens.

9. The illuminating device for a microscope according to claim 7, wherein an optical directional member inclined by a retainer is inclined so as to lie generally in a plane that is not perpendicular to the optical axis of the objective lens.

10. An illuminating device for a microscope comprising:
an optically transparent sample mounting plate for mounting a sample;
a surface light source that emits substantially uniform illuminating light toward the sample mounting plate; and
optical directional members that limit diffusion of the illuminating light between the surface light source and the sample mounting plate;
wherein
a prism sheet is arranged between the optical directional members and the sample mounting plate.

11. The illuminating device for a microscope according to claim 10, wherein the optical directional members are equipped with a switching mechanism that selectively arranges one of different types of optical directional members between the sample mounting plate and the surface light source.

12. The illuminating device for a microscope according to claim 11, wherein the different types of optical directional members include a fiber optic plate.

13. The illuminating device for a microscope according to claim 11, wherein the different types of optical directional members include a capillary plate.

14. The illuminating device for a microscope according to claim 10, wherein an optical directional member is mounted on a retainer so as to retain and incline the optical directional member at an angle relative to the sample mounting plate.

15. The illuminating device for a microscope according to claim 11, wherein an optical directional member is mounted on a retainer so as to retain and incline the optical directional member at an angle relative to the sample mounting plate.

16. The illuminating device for a microscope according to claim 12, wherein an optical directional member is mounted on a retainer so as to retain and incline the optical directional member at an angle relative to the sample mounting plate.
